(19) United States
(12) Patent Application Publication
(10) Pub. No.: US 2008/0025050 A1
(43) Pub. Date: Jan. 31, 2008

(54) Wide Input Range Power Supply

(75) Inventor: Leonid Spindler, Lod (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: LV Power (2003) Ltd., Tzur Yigal (IL)

(21) Appl. No.: 11/623,755

(22) Filed: Jan. 17, 2007

Related U.S. Application Data
(63) Continuation-in-part of application No. 11/459,648, filed on Jul. 25, 2006.

(51) Int. Cl. H02M 3/22

(52) U.S. Cl. 363/15

(57) ABSTRACT

A series resonant converter (SRC) power supply with a wide input range and high efficiency includes at least one SRC connected to a respective at least one synchronous/asynchronous rectifier operative to receive phase control. Efficient power conversion in a wide input voltage range of about 1:11 is achieved by using both frequency control of the SRC and phase control of phase differences between a voltage signal inside the SRC and a voltage signal inside the respective at least one synchronous/asynchronous rectifier coupled to the SRC. Preferably, the phase control is applied, alone or in combination with additional frequency control, after the phase difference reaches 90 degrees and up to a phase difference of 180 degrees.

### CROSS REFERENCE TO RELATED APPLICATIONS

The present invention is a Continuation in Part of U.S. patent application Ser. No. 11/459,648 filed Jul. 25, 2006.

### FIELD OF THE INVENTION

The present invention relates to electrical power supplies (PS) and in particular to Series Resonant Converter (SRC) power supplies having a wide range of input voltages.

### BACKGROUND OF THE INVENTION

Modern power supplies based on pulse width modulation (PWM) are known. Some of these supplies have an input voltage (Vᵢₙ) range of 2-3 (e.g. 36-72 VDC or 86-264 VAC) and operate at frequencies of 50 KHz-1 MHz. Exemplary applications that require the full range include Compact PCI. Normally, such power supplies include separate AC/DC and DC/DC conversion modules. Attempts to get a wider input range are limited by the efficiency losses introduced by high frequency operation, see below.

The general architecture of existing power supplies is illustrated with the help of the block diagrams of FIGS. 1a and 1b. Corresponding waveforms are shown in FIGS. 1c and 1d. FIG. 1a shows a prior art PS 100 that includes an input block 102 typically having an input rectifier and an EMI filter (not shown), a series resonant converter (SRC) 104 for converting a DC voltage into a high frequency AC voltage, a synchronous rectifier 106 for converting the high frequency AC voltage into a required output DC voltage Vₒᵤₜ, a control unit 108 and an output block 110 that includes a load R_{L} and a capacitor C connected in parallel. The magnitude of the impedance Z in the SRC is a function of its operating frequency. That is, low frequency=low impedance and high frequency=high impedance. Input block 102 is configured to receive a range of AC or DC input voltages, for example between 36-72 VDC or 86-264 VAC. The control unit preferably includes a frequency control module or function 112. Arrow 124 indicates frequency control and arrow 120 represents a feedback of voltage signals after SRC 206, which are input to control unit 108.

FIG. 1b shows a prior art PS 100′ that includes an input block 102′ typically having an input rectifier and an EMI filter (not shown), a series resonant converter (SRC) 104′ for converting the DC voltage into a high frequency AC voltage, an asynchronous rectifier 106′ for converting the high frequency AC voltage into a required output DC voltage Vₒᵤₜ, a control unit 108′ and an output block 110′ that includes a load R_{L} and a capacitor C connected in parallel. Input block 102′ is configured to receive a range of AC or DC input voltages, for example between 36-72 VDC or 86-264 VAC. The control unit preferably includes a phase control module or function 114 for controlling the asynchronous rectifier. Arrow 126 indicates phase control and arrow 122 represents a feedback of voltage signals after asynchronous rectifier 106′, which are input to control unit 108′.

Frequency control of synchronous rectifiers and phase control of asynchronous rectifiers is well known in the art, and described for example in M, K. Kazimierczuk, IEEE Transactions on Industrial Electronics, Vol. 38, No. 5, pp. 344-354, 1991 and M. Mikotajewski, IEEE Transactions on Industrial Electronics, Vol. 38, No. 5, pp. 694-697, 1991. However, while separate control of frequency (in synchronous power supplies) and phase (in asynchronous power supplies) is known, the combined use of these two controls to affect the input range and output load in a single power supply that outputs a constant DC voltage is not known.

FIGS. 1c and 1d show voltage and current waveforms through the SRC and either the synchronous (FIG. 1a) or asynchronous (FIG. 1b) rectifier of respectively power supplies 100 and 100′. Δφ represents a phase shift between the voltage signal at the output of the SRC (150 and 150′ respectively) and the voltage signal at the output of the rectifier (152 and 152′ respectively). This phase shift can be changed by changes in the frequency applied to the SRC (in PS 100) or changes in phase applied to the asynchronous rectifier (in PS 100′). ZVS stands for “Zero Voltage Switch”, which is implemented in well known ways in components 104, 106 (PS 100), and 104′, 106′ (PS 100′).

For prior art power supply 100, when any factor affects Vₒᵤₜ, e.g. when the input voltage Vᵢₙ increases, the operating conversion frequency F increases as well. This causes the series impedance Z to increase, in order to keep Vₒᵤₜ constant. The problem with the existing technology is that if Vᵢₙ changes by a factor of X, then the operating frequency has to change by approximately the same factor X. Present technology allows the maximum variation in the input voltage range (and the variation in frequency) to vary by a factor of 2 in the telecom input range from 36 VDC to 75 VDC or by a factor of 4 (input voltages from 118 VDC to 370 VDC or 86 VAC to 264 VAC) in other uses. The reason for this is that current materials used in power conversion are optimized at an operating frequency of between 100-300 KHz. If the operating conversion frequency is much smaller than this, the component size, weight, and cost increase. If the operating frequency is much higher (say 1 Mhz), the size of the components in the PS decreases, but many other factors that increase losses become dominant. These include the skin effect, the proximity effect, the pulse width modulation (PWM) resolution, dynamic losses, etc. Consequently, at such high frequencies, the PS losses would be in the range of 15-20%.

The change in F causes a relative change in the voltage. Specifically, increasing F causes a decrease in Vₒᵤₜ. Most power supplies limit the F changes to a maximum factor of about 4 to compensate for Vᵢₙ changes between 86 VAC and 264 VAC and for load changes. The frequency limitation limits the input voltage range to about the same factor.

Special power supplies such as TV plasma power supplies may have a change in operating frequency of 1:10, but this severely reduces their operating efficiency to about a maximum of 80%. It would therefore be extremely advantageous to have power supplies that can extend the Vᵢₙ range to much higher values, for example from 36 to 400 VDC (or equivalently 25 to 283 VAC), while at the same time ensuring high efficiencies

### SUMMARY OF THE INVENTION

The present invention relates to a universal (both AC/DC and DC/DC), wide input range SRC power supply capable of handling input voltage changes by a factor of 11 with high conversion efficiency. Inventively, and in contrast with prior art, the large Vᵢₙ range is enabled by the use of a much smaller operating frequency range (by exemplarily a factor 2-3). Instead of requiring F to change by about the same factor as Vᵢₙ (11), a PS of the present invention requires F changes by only a factor of 2-3 to maintain a constant Vₒᵤₜ. To provide this capability, a PS of the present invention includes a synchronous/asynchronous rectifier. As used herein, a “synchronous/asynchronous rectifiers” is a active rectifier that is operated in such a way so that it combines the functions of both synchronous and asynchronous rectifiers In particular, a synchronous/asynchronous rectifier of the present invention may be both frequency controlled (when in synchronous mode) and phase-controlled (when in asynchronous mode).

The limitation of the use of a small F range to allow a large Vᵢₙ range requires an additional conversion control factor in the form of phase control. In the present invention, F is varied as a single control factor only up to the frequency for which there is a 90° change (shift) in Δφ. The change in F needed to reach the 90° phase shift under conditions of no load and maximum Vᵢₙ varies, depends also on the circuitry, and is arbitrarily limited herein to about 3. After reaching the 90° phase change, the phase at the rectifier input is varied by up to another 90° either solely by use of a phase controller, or by a combination of phase and frequency controls. The total change in the phase between the SRC voltage and the voltage on the rectifier is thus able to vary by a full 180° range, while the input frequency has been varied only by a 2-3 ratio. A full 180° change in phase will cause Vₒᵤₜ to vary all the way down to zero. In a preferred embodiment, this 180° variation in phase between the SRC and synchronous/asynchronous rectifier voltages thus allows for a constant regulated voltage at the output while the input voltage is varied in amplitude by a ratio of 11, something unattainable with high efficiency in prior art.

According to the present invention there is provided a power supply comprising an input block operative to receive AC or DC input voltage signals in a given input voltage range and to output a DC voltage signal, a series resonant converter for receiving the DC voltage signal and for outputting a corresponding high frequency ac voltage signal, a synchronous/asynchronous rectifier for converting the high frequency AC voltage signal into a set DC voltage, and a control unit having a frequency control module for providing inputs to the SRC and a phase control module for providing inputs to the synchronous/asynchronous rectifier, the control unit used to ensure that the set output DC voltage remains substantially constant

In an embodiment, the phase control module is operative to control a phase difference between the high frequency AC voltage signal in the SRC and a corresponding high frequency AC voltage signal in the synchronous/asynchronous rectifier when the phase difference exceeds 90°.

In an embodiment, the power supply further includes an output block operative to output the set DC voltage to a load.

In an embodiment, the control unit is implemented in a single integrated chip.

In an embodiment, the frequency control module is operative to increase the corresponding high frequency by a certain value for phase differences of up to 90°.

In an embodiment, the integrated chip is a digital signal processor (DSP) chip.

According to the present invention there is provided a method for power conversion in a series resonant converter power supply with a wide input range, the method comprising steps of providing a power supply that includes an input block operative to receive universal AC or DC input voltages in a given input voltage range and to output a DC voltage, a SRC for receiving the DC voltage from the input block and for outputting a corresponding high frequency ac voltage, a synchronous/asynchronous rectifier for converting the high frequency ac voltage into a set DC output voltage and a control unit having a frequency control module and a phase control module and used to ensure that the set output DC voltage remains substantially constant; and using both frequency control and phase control to keep the set DC output voltage substantially constant upon any changes of the input voltage over the input range output current or temperature changes.

In an embodiment, the step of using both frequency control and phase control includes using the frequency control to control a phase difference between the SRC and the synchronous/asynchronous rectifier and the impedance of the SRC before the phase difference reaches 90°, and using the phase control to control the phase difference between the SRC and the synchronous/asynchronous rectifier and the impedance of the SRC when the phase difference exceeds 90°.

According to the present invention there is provided a power supply comprising: an input block operative to receive both alternating current (ac) and direct current (DC) input voltage signals in a given input voltage range and to output a DC voltage signal; a plurality of legs having a predetermined phase shift therebetween, each leg including a series resonant converter (SRC) for receiving the DC voltage signal and for outputting a corresponding high frequency ac voltage signal, a synchronous/asynchronous rectifier for converting the high frequency ac voltage signal into a set DC voltage; and a control unit having a frequency control module for providing frequency controls to the SRC and a phase control module for providing phase controls to the synchronous/asynchronous rectifier, whereby the frequency and phase controls are used to keep a set output voltage of the power supply substantially constant

In an embodiment, the plurality of legs includes N legs having a predetermined phase shift of 180/N degrees therebetween.

In an embodiment, the given input voltage range is 1:11.

In an embodiment, the input voltage range of 1:11 includes a range of 36 to 400 VDC or equivalently 22 to 283 VAC

According to the present invention there is provided a method for power conversion in a series resonant converter power supply with a wide input range comprising steps of: providing, in the power supply, at least one SRC connected to a respective at least one synchronous/asynchronous rectifier; using frequency control to keep a set output DC voltage constant while a phase difference of voltage signal phases in the SRC and the synchronous/asynchronous rectifier is lower than 90°; and using at least a phase control to keep the set output DC voltage constant when the phase difference between the voltage signal phases exceeds 90°, thereby achieving high efficiency over a wide given input voltage range.

In an embodiment, the step of using at least a phase control includes using the phase control in combination with a frequency control.

In an embodiment, the step of providing at least one SRC connected to a respective at least one synchronous/asynchronous rectifier includes providing a plurality N of legs, each including a SRC connected to a synchronous/asynchronous rectifier, the plurality of legs having a predetermined phase shift of 180/N degrees therebetween.

According to the present invention there is provided a method for power conversion in a SRC power supply comprising steps of providing an input block operative to receive both AC and DC input voltage signals in a given input voltage range and to output a DC voltage signal; providing a plurality of legs having a predetermined phase shift therebetween, each leg including a SRC for receiving the DC voltage signal and for outputting a corresponding high frequency ac voltage signal, a synchronous/asynchronous rectifier for converting the high frequency ac voltage signal into a set DC voltage, and a control unit having a frequency control module for providing frequency controls to the SRC and a phase control module for providing phase controls to the synchronous/asynchronous rectifier; and using at least one of the frequency or phase controls to provide a substantially constant power supply output voltage while keeping frequency changes in each SRC limited to a predetermined value.

In an embodiment, the step of using at least one of the frequency or phase controls to provide a substantially constant power supply output voltage while keeping frequency changes in each SRC limited to a predetermined value includes using frequency control until the frequency reaches the predetermined value and shutting off a leg to return the frequency to an original frequency value.

### BRIEF DESCRIPTION OF THE DRAWINGS

The invention is herein described, by way of example only, with reference to the accompanying drawings, wherein:

FIG. 1 shows schematically prior art Series Resonant Converter (SRC) power supplies: a) with a synchronous rectifier architecture; b) with an asynchronous rectifier architecture; c) waveforms through the SRC and the rectifier of FIG. 1a; d) waveforms through the SRC and the rectifier of FIG. 1b;

FIG. 2 shows schematically a first embodiment of a SRC power supply of the present invention having an SRC and a synchronous/asynchronous rectifier;

FIG. 3 shows voltage and current waveforms through the SRC and synchronous/asynchronous rectifier of the PS of FIG. 2;

FIG. 4 shows schematically a second embodiment of a SRC power supply of the present invention having three separate legs with phase frequency and phase control units;

FIG. 5 shows voltage and current waveforms through the SRC and synchronous/asynchronous rectifier of the PS of FIG. 4.

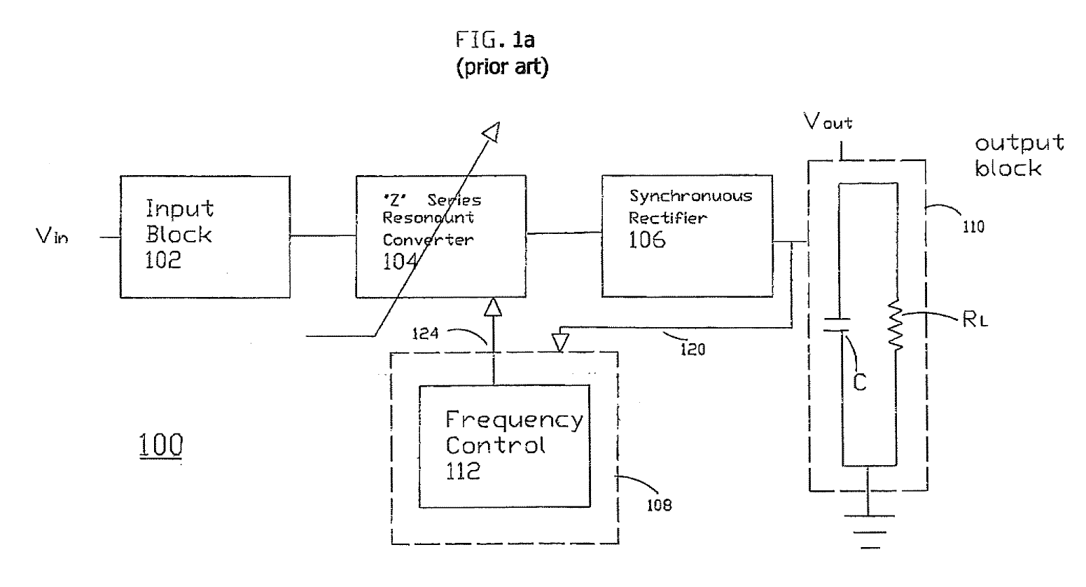

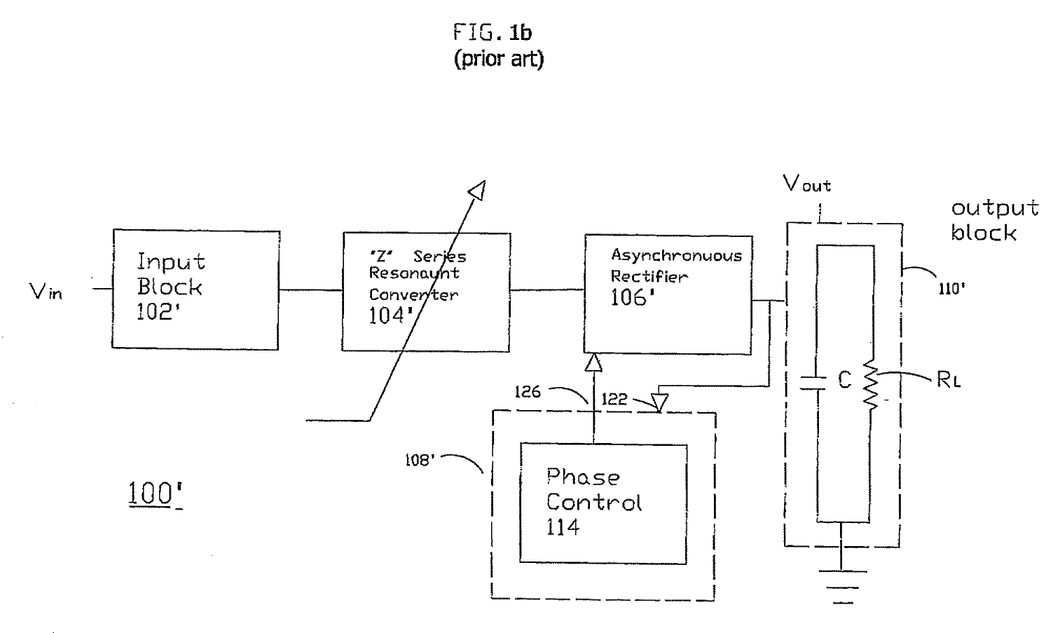

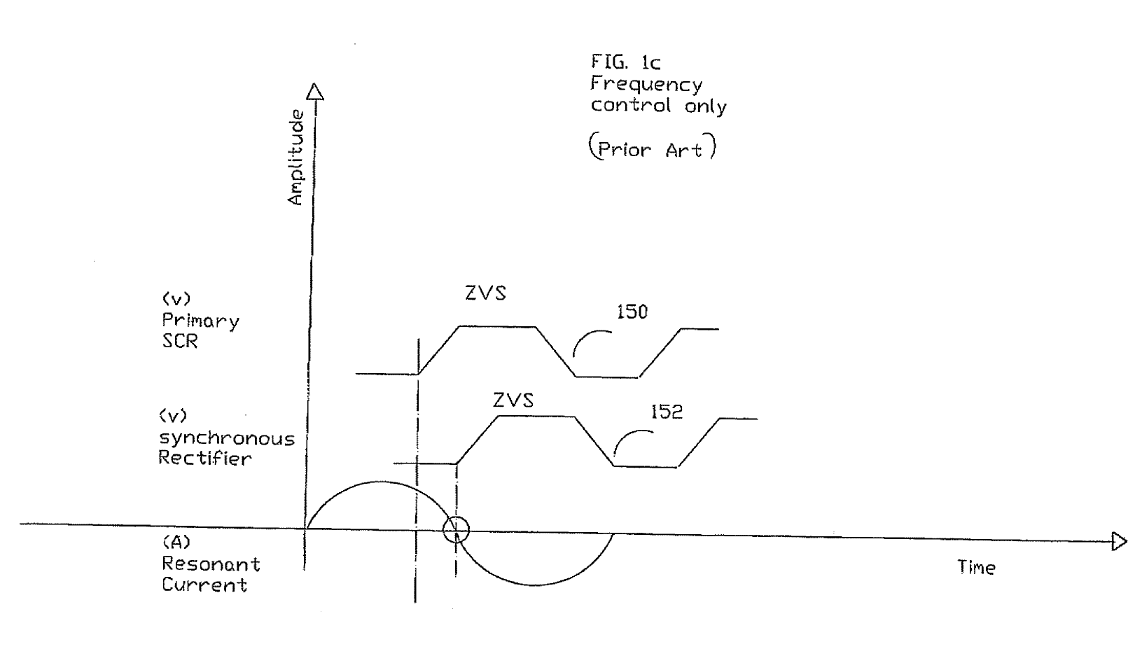

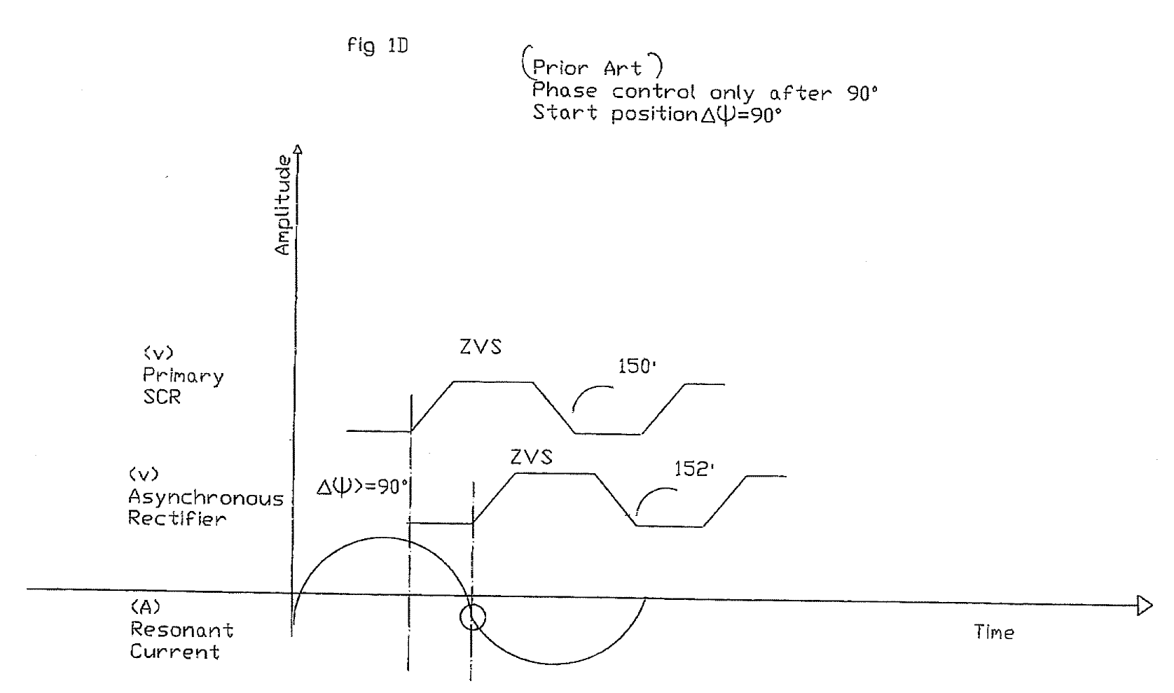

### DETAILED DESCRIPTION OF THE INVENTION

The present invention relates to power supplies that have a wide voltage input range that accommodates both AC and DC signals. Exemplarily, and in contrast with prior art, a PS of the present invention can have an input voltage ranging from 22 to 283 VAC or from 32 to 400 VDC. The output of the PS can be set to a much lower DC voltage, exemplarily 12 VDC.

In order to accommodate such a wide input range of voltages and execute the conversion with a high efficiency, the present invention advantageously uses phase control in addition to frequency control in the same unit. This inventive aspect will be better understood through the detailed description that follows.

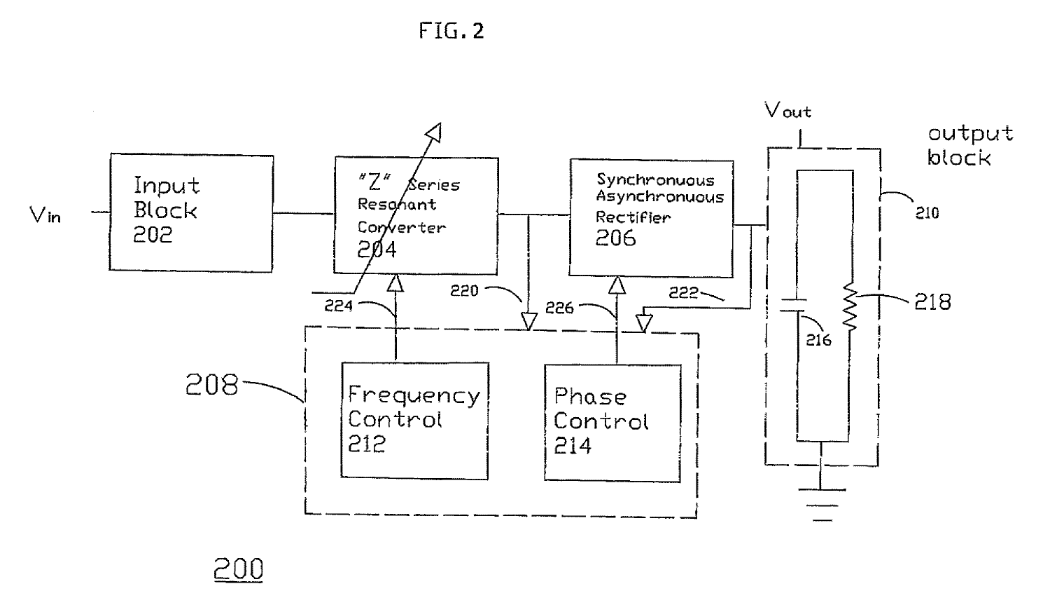

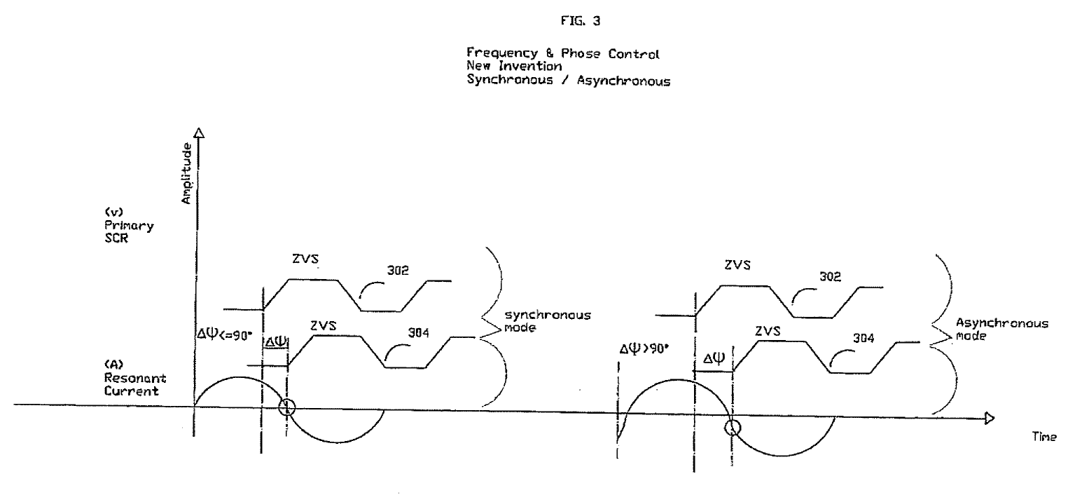

FIG. 2 shows a first embodiment of a power supply 200 of the present invention, with various elements interconnected as shown. FIG. 3 shows voltage and current waveforms through the SRC and synchronous/asynchronous rectifier of the PS of FIG. 2. In FIG. 2, PS 200 includes an input block 202 typically having an input rectifier and an EMI filter (not shown) operative to receive an input voltage with a voltage Vin, and to output a pulsed rectified high DC voltage (or just a regular DC voltage if the input to block 202 was VDC); a series resonant converter (SRC) 204 for converting the regular or pulsed rectified DC voltage into a high frequency AC voltage (typically 150-300 KHz); a synchronous/asynchronous rectifier 206 for converting the high frequency AC voltage into an equal DC voltage Vₒᵤₜ; a control unit 208 and an output block 210. Input block 202 is configured to receive a wide range of AC and DC input voltages, for example between 36 and 400 VDC (or equivalently 22-283 VAC). AC voltages are normally input at line frequencies i.e. 50-60 Hz. The control unit preferably includes a frequency control module or function 212 and a phase control module or function 214. Unit 208 may be implemented in a single digital signal processor (DSP) module or chip. An exemplary DSP module that can serve as unit 208 is component TMS320F2806 from Texas Instruments. Module 212 is operative to control the frequency of a voltage signal 302 (FIG. 3) through SRC 204 and module 214 is operative to control the phase of a voltage signal 304 (FIG. 3) through rectifier 206. The output block typically includes a parallel connection of a load capacitor 216 and a load resistor 218, and is configured to output a substantially constant regulated low voltage, typically between 1-48 VDC. Arrows 220 and 222 represent respectively feedbacks of non-rectified and rectified voltage signals before and after rectifier 206, which are input to control unit 208. Arrows 224 and 226 indicate respectively frequency control and phase control.

In use, the low input frequency AC voltage signal is converted into a rectified DC voltage signal and input to SRC 204, where it is converted further into a high frequency AC voltage signal. The high frequency AC voltage signal has a peak amplitude of Vᵢₙ at typically 150-300 KHz. This signal is then input to synchronous/asynchronous rectifier 206, which rectifies it to Vₒᵤₜ. Vₒᵤₜ is selected to be at a constant DC value (e.g. 12V). Vₒᵤₜ is checked constantly and, if any parameters affecting Vₒᵤₜ change, (for example Vᵢₙ, the load changes, the temperature, etc), actions are performed to keep Vₒᵤₜ constant.

Assume exemplarily that Vᵢₙ increases. As in all resonant converter power supplies, F is now increased, causing series impedance Z (in SRC 204) to increase, thus lowering the output voltage to the set constant Vₒᵤₜ. However, the increase in F also increases the Δφ between the voltage signals in the SRC and in rectifier 206. As long as Δφ≦90°, Vₒᵤₜ is controlled solely by F changes. For a Δφ between ca. 30-90 degrees, rectifier 206 is in synchronous mode (i.e. the PS is in “synchronous rectifier” mode). For 90°<Δφ≦180°, rectifier 206 is in asynchronous mode (i.e. the PS is in “asynchronous rectifier” mode). Inventively and in contrast with prior art, in one embodiment of the present invention, when Δφ>90° (and up to 180°), further attempts to keep Vₒᵤₜ constant are achieved either solely by phase control changes applied to rectifier 206 (in asynchronous mode) or by phase control changes applied to rectifier 206 (in asynchronous mode) in combination with further frequency control applied to SRC 204. In both embodiments (phase control alone or combined phase and frequency control), the phase control works in the same direction as the F control, when 90°<Δφ≦180° i.e. to increase the impedance Z in SCR 204 and the phase in the rectifier. Application of phase control together with F control allows faster adjustment of Vₒᵤₜ to Vᵢₙ changes.

The full or partial replacement of frequency control by phase control when 90°<Δφ≦180° is a key inventive feature of the present invention, which allows the Vᵢₙ range to be much wider (up to 11) than in existing power supplies without sacrificing efficiency by increasing F. The efficiency remains high because the F swing is limited to about 2. The power supply of the present invention is universal, accommodating both AC and DC inputs.

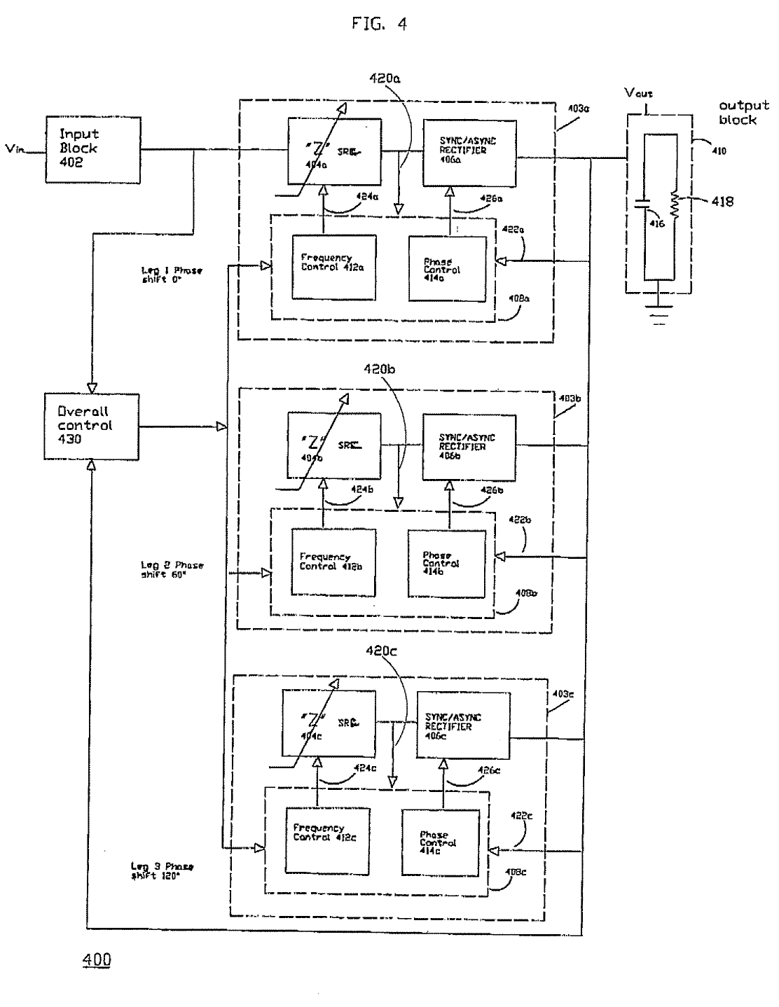

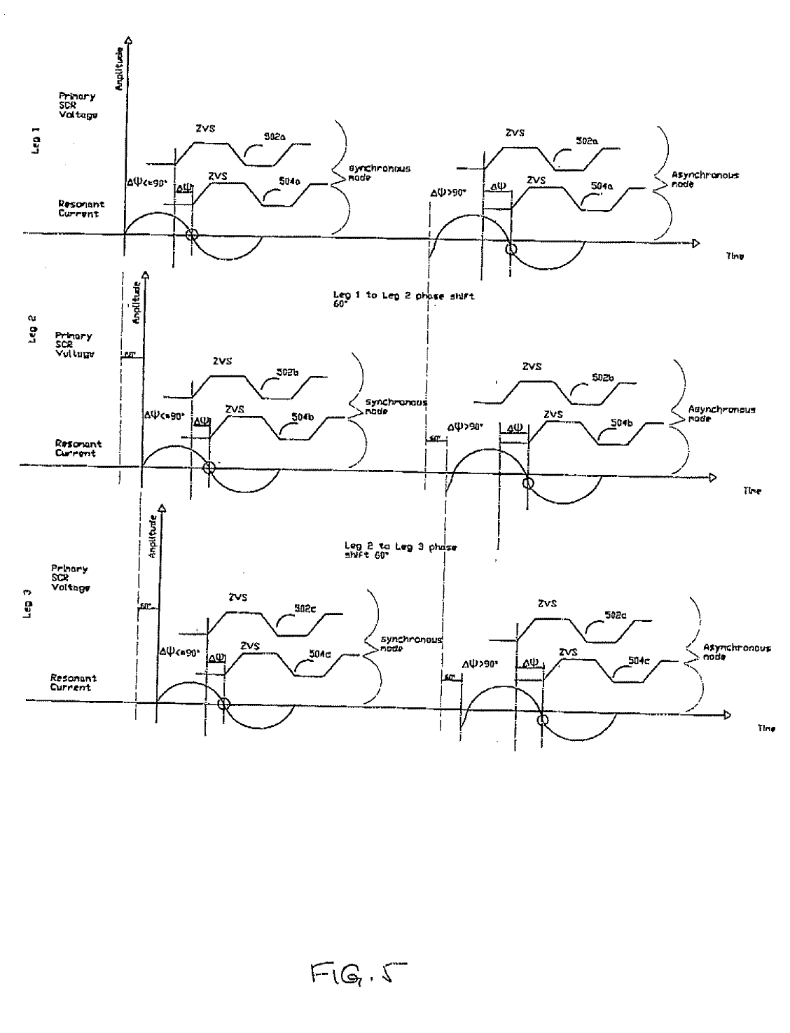

FIG. 4 shows schematically another frequency plus phase controlled power supply 400 of the present invention, with various elements interconnected as shown. In common with PS 200 of FIG. 2, PS 400 comprises an input block 402 typically having an input rectifier and an EMI filter (not shown). Input block 402 is operative to receive an input voltage with a voltage Vᵢₙ and to output a pulsed rectified DC voltage (if Vᵢₙ is AC) or regular DC voltage (if Vᵢₙ is DC). PS 400 further comprises an output block 410, which typically includes a parallel connection of a load capacitor 416 and a load resistor 418, and which is configured to output a substantially constant regulated low voltage Vₒᵤₜ, typically between 1-48 VDC. In contrast with PS 200, PS 400 further comprises a plurality N (here exemplarily 3) of separate frequency and phase control subsystems (referred to hereinafter as “legs”), the legs shifted in phase therebetween by 180/N degrees. PS 400 is accordingly referred to as a “multiple-leg PS”. Continuing with the exemplary 3-leg system 400, the three legs 403a, 403b and 403c are phase-shifted by 60° there between. Each leg 403 includes a series resonant converter (respectively 404a, 404b and 404c), a synchronous/asynchronous rectifier (respectively 406a, 406b and 406c) and a subsystem control unit (respectively 408a, 408b and 408c). Each leg control unit includes a respective frequency control module or function 412a, 412b and 412c and a respective phase control module or function 414a, 414b and 414c. Each module 412 is operative to control the frequency of a voltage signal 502 (FIG. 5) through a respective SRC 404 and each module 414 is operative to control the phase of a voltage signal 504 (FIG.5) through a respective synchronous/asynchronous rectifier 406. In some embodiments, control units 408 and 430 may have their control functions unified in a single module. The functions of the series resonant converters, the synchronous/asynchronous rectifiers and the frequency and phase control modules is identical with that described for PS 200. Arrows 420a, 420b and 420c and 422a, 422b and 422c represent respectively feedbacks of non-rectified and rectified voltage signals before and after rectifiers 406a, 406b and 406c respectively, the signals input to respective control units 408a, 408b and 408c. Further in contrast with PS 200, PS 400 may further comprise an overall control unit 430 for overall control of the various components.

All the control units may be implemented in a single digital signal processor (DSP) module or chip. An exemplary DSP module that can serve as either a leg control unit, a central control unit or a unified control unit is component TMS320F2806 from Texas Instruments.

In use, the incorporation of three separate frequency and phase controlled legs enables use of smaller frequency F increases to achieve the same goal. Assume worst case conditions in which Vᵢₙ is smallest (i.e. 36 VDC), that load 418 is very large (maximum), and that the temperature is at a maximum allowed. Under these operating conditions, the input frequency is lowest (F₀) and the phase shift is up to 45° (e.g. between voltage waveforms 502a,b,c and 504a,b,c, FIG. 5). Any change in any of these conditions will cause Vₒᵤₜ to increase. Assume now that Vₒᵤₜ chances (increases) as a result of a change in one or more of these parameters. As in all resonant converter power supplies, in order to maintain Vₒᵤₜ constant, F needs to increase. All three legs are activated to operate in frequency control mode. Assume that we wish to limit the change in F to a change smaller than ×2 (for example ×1.1 F₀). Both phase and frequency are actively monitored. If the phase shift increases and reaches 90° before F reaches ×1.1 F₀ and it Vₒᵤₜ is still not stabilized then all legs operate in phase control until Vₒᵤₜ is stabilized. If however F reaches ×1.1 F₀ before the phase shift reaches 90°, then one leg (exemplarily 403a) is shut off, causing F to revert to F₀. Assume Vₒᵤₜ is still not stable. In continuation, the change in F is limited again to ×1.1 F₀, while the phase shift is monitored. If the phase shift increases to 90° before F reaches ×1.1 F₀ and if Vₒᵤₜ is still not stabilized then the two legs left (403b and 403c) operate in phase control until Vₒᵤₜ is stabilized. If however F reaches ×1.1 F₀ before the phase shift reaches 90°, a second leg (exemplarily 403b) is now shut off, causing F to revert to F₀. In continuation, the change in F is limited again to ×1.1 F₀, while the phase shift is monitored. If the phase shift increases to 90° before F=×1.1 F₀ and if Vₒᵤₜ is still not stabilized, then the remaining leg (403c) operates phase control until Vₒᵤₜ is stabilized.

To summarize, in all embodiments, the phase control kicks in only after a phase shift of 90°. The frequency control is active up to a phase shift of 90°, and after the 90° phase shift together with the phase control if the variance in frequency control (reaching the set limit of F) is still not complete by the time the 90° phase shift is reached. If the set F limit is 2 F₀ and the 90° phase shift is reached when F=1.5 F₀, then after 90°, both frequency control and the phase control participate in changing the phase. The frequency control will then “stop its participation” by when F=2 F₀, while the phase control will continue operating until Vₒᵤₜ is stabilized.

Advantageously, the system and method described allow stabilization of the output voltage even when the input voltage changes in a wide range, without similarly is large changes in the frequency. In fact, the frequency needed to accommodate a Vᵢₙ change by a factor of Y can be kept below a factor of about Y/4 for a “single leg” PS and a factor of about Y/5 for a “multi-leg” PS.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made. For example, the Vᵢₙ range may be further extended to say 1:15, with attendant changes in the limit imposed on the F change (say up to 4 F₀).

What is claimed is:

1. A power supply comprising:
a. an input block operative to receive alternating current (AC) or direct current (DC) input voltage signals in a given input voltage range and to output a DC voltage signal;
b. a series resonant converter (SRC) for receiving the DC voltage signal and for outputting a corresponding high frequency ac voltage signal;
c. a synchronous/asynchronous rectifier for converting the high frequency AC voltage signal into a set DC voltage; and
d. a control unit having a frequency control module for providing inputs to the SRC and a phase control module for providing inputs to the synchronous/asynchronous rectifier, the control unit used to ensure that the set output DC voltage remains substantially constant

2. The power supply of claim 1, wherein the phase control module is operative to control a phase difference between the high frequency AC voltage signal in the SRC and a corresponding high frequency AC voltage signal in the synchronous/asynchronous rectifier when the phase difference exceeds 90 degrees.

3. The power supply of claim 2, wherein the given input voltage range extends to 1:11.

4. The power supply of claim 1, further comprising an output block operative to output the set DC voltage to a load.

5. The power supply of claim 1, wherein the control unit is implemented in a single integrated chip.

6. The power supply of claim 3, wherein the frequency control module is operative to increase the corresponding high frequency by a factor of up to 2 for phase differences of up to 90 degrees

7. The power supply of claim 5, wherein the integrated chip is a digital signal processor chip.

8. A method for power conversion in a series resonant converter (SRC) power supply with a wide input range, comprising steps of:
a, providing a power supply that includes:
i. an input block operative to receive universal alternating current (AC) or direct current (DC) input voltages in a given input voltage range and to output a DC voltage,
ii. a SRC for receiving the DC voltage from the input block and for outputting a corresponding high frequency AC voltage,
iii. a synchronous/asynchronous rectifier for converting the high frequency AC voltage into a set DC output voltage, and
iv. a control unit having a frequency control module and a phase control module and used to ensure that the set output DC voltage remains substantially constant; and
b. using both frequency control and phase control to keep the set DC output voltage substantially constant upon changes of the input voltage over the input range.

9. The method of claim 8, wherein the step of using both frequency control and phase control includes:
i. using the frequency control to control a phase difference between the SRC and the synchronous/asynchronous rectifier before the phase difference reaches 90 degrees, and
ii. using the phase control to control the phase difference between the SRC and the synchronous/asynchronous rectifier when the phase difference exceeds 90 degrees.

10. The method of claim 8, wherein the given input voltage range extends to 1:11.

11. The power supply of claim 10, wherein the input voltage range of 1:11 includes a range of 36 to 400 VDC or equivalently 22 to 283 VAC

12. A power supply comprising:
a. an input block operative to receive both alternating current (AC) and direct current (DC) input voltage signals in a given input voltage range and to output a DC voltage signal;
b. a plurality of legs having a predetermined phase shift therebetween, each leg including:
i. a series resonant converter (SRC) for receiving the DC voltage signal and for outputting a corresponding high frequency ac voltage signal,
ii. a synchronous/asynchronous rectifier for converting tile high frequency ac voltage signal into a set DC voltage, and
iii. a control unit having a frequency control module for providing frequency controls to the SRC and a phase control module for providing phase controls to the synchronous/asynchronous rectifier;
whereby the frequency and phase controls are used to keep a set output voltage of tile power supply substantially constant.

13. The power supply of claim 12, wherein the plurality of legs includes N legs having a predetermined phase shift of 180/N degrees therebetween.

14. The power supply of claim 12, wherein the given input voltage range is 1:11.

15. The power supply of claim 14, wherein the input voltage range of 1:11 includes a range of 36 to 400 VDC or equivalently 22 to 283 VAC

16. A method for power conversion in a series resonant converter (SRC) power supply with a wide input range comprising steps of:
a. providing, in the power supply, at least one SRC connected to a respective at least one synchronous/asynchronous rectifier;
b. using frequency control to keep a set output DC voltage constant while a phase difference of voltage signal phases in the SRC and the synchronous/asynchronous rectifier is lower than 90 degrees; and
c. using at least a phase control to keep the set output DC voltage constant when the phase difference between the voltage signal phases exceeds 90 degrees, thereby achieving high efficiency over a wide given input voltage range.

17. The method of claim 16, wherein the step of using at least a phase control includes using the phase control in combination with a frequency control.

18. The method of claim 16, wherein the step of providing at least one SRC connected to a respective at least one synchronous/asynchronous rectifier includes providing a plurality N of legs, each including a SRC connected to a synchronous/asynchronous rectifier, the plurality of legs having a predetermined phase shift of 180/N degrees therebetween.

19. A method for power conversion in a series resonant converter (SRC) power supply comprising steps of:
a. providing an input block operative to receive both alternating current (AC) and direct current (DC) input voltage signals in a given input voltage range and to output a DC voltage signal;
b. providing a plurality of legs having a predetermined phase shift therebetween, each leg including:
i. a SRC for receiving the DC voltage signal and for outputting a corresponding high frequency ac voltage signal,
ii. a synchronous/asynchronous rectifier for converting the high frequency ac voltage signal into a set DC voltage, and
iii. a control unit having a frequency control module for providing frequency controls to the SRC and a phase control module for providing phase controls to the synchronous/asynchronous rectifier; and
c. using at least one of the frequency or phase controls to provide a substantially constant power supply output voltage while keeping frequency changes in each SRC limited to a predetermined value.

20. The method of claim 19, wherein the step of using at least one of the frequency or phase controls to provide a substantially constant power supply output voltage while keeping frequency changes in each SRC limited to a predetermined value includes using frequency control until the frequency reaches the predetermined value and shutting off a leg to return the frequency to an original frequency value.
